(19) United States
(12) Patent Application Publication
(10) Pub. No.: US 2014/0119487 A1
(43) Pub. Date: May 1, 2014

(54) System for generating particles

(71) Applicant: A. Christian Tahan, Cambridge, MA (US)

(72) Inventor: A. Christian Tahan, Cambridge, MA (US)

(21) Appl. No.: 13/665,928

(22) Filed: Oct. 31, 2012

(51) Int. Cl. G21G 1/00

(52) U.S. Cl. CPC G21G 1/00
USPC 376/156

(57) ABSTRACT

Exposing isotopes aligned in a sufficiently strong magnetic field to extremely low electromagnetic frequencies results in the production of different isotopes. The method and apparatus also permits the production of subatomic particles.

### RELATED APPLICATIONS

This application is a continuation in part of U.S. patent application Ser. No. 12/361,540, filed Jan. 28, 2009, and also claims the benefit of Provisional Application No. 61/553,255, filed Oct. 31, 2011, and claims the benefit of Provisional Application No. 61/694,780, filed Aug. 30, 2012.

### FIELD OF THE INVENTION

This invention relates to a novel system for generating particles that can also result in isotope production. The process, in one embodiment, can produce Technetium-99m (Tc-99m) from stable Molybdenum (Mo) powder.

### BACKGROUND OF THE INVENTION

Shortages of medical isotopes are continuous concerns since dependant procedures may be unavailable. The unpredictability of aging reactors and the shutting-down of the two main producers of Molybdenum-99 (Mo-99) for Technetium-99m (Tc-99m) (Hoag, H. (2007) Nature 450(7172), p. 926; Dance, A. (2008) Nature, doi: 10.1038/news.2008.1072.) have caused governments (U.S. Committee on Energy and Commerce, “The American Medical Isotopes Production Act of 2009.”) and the medical community to look for alternative providers. (“Expert Panel: Forecast Future Demand for Medical Isotopes,” U.S. Department of Energy, Arlington, Va. (1998).) Production has involved transporting Mo-99 from the sourcing nuclear reactor to usually a hospital that will use a “⁹⁹Mo/”^{99m}Tc generator to produce the isotope: Mo-99→Tc-99m,e⁻, v̅ₑ.

The method and apparatus (the invention) was demonstrated in the laboratory could directly produce Tc-99m from standard Mo powder without the need of a typical generator. Tc-99m is used in medical exams particularly since the gamma ray emissions are readily detectable. (Emsley, J. (2001). Nature's Building Blocks: An A-Z Guide to the Elements, New York: Oxford University Press.) Tc-99m is incorporated in nearly eighty-five percent of nuclear medicine imaging: twenty million diagnostic procedures yearly. Thirty-one radiopharmaceuticals are based on Tc-99m for imaging and functional studies. (Schwochau, K. (2000). Technetium: Chemistry and Radiopharmaceutical Applications, Wiley-VCH.)

### SUMMARY OF THE INVENTION

Subjecting sulfuric acid in a magnetic field, primarily 0.2 T, to extremely low frequency radio waves was found in one embodiment could lead to neutrons due to electron captures and consequently isotopes by neutron captures. The room temperature process, i.e. operating the invention in a room without the need to adjust the temperature of the room or the apparatus for the process, is innovative since neutrons are typically only sourced from nuclear disintegrations and reactions or specific high-energy reactions, e.g. accelerator collisions. Standard Mo powder (Fisher subsieve 4.3 um), non-enriched, was mixed in the acid (always 20 mL), and 141 keV readings corresponding to Tc-99m were detected in samples removed from the apparatus. The Fisher subsieve size was reduced (average microns ≈1.52 (as supplied)) resulting in greater counts for Tc-99m with a NaI scintillator detector.

The invention can easily be made and used by placing a tube or holding vessel, in one embodiment a neutron reflective graphite tube, in a moderately strong magnetic field, in one embodiment 2000 Gauss, and placing a particle source in the tube, in one embodiment 20.mL sulfuric acid. Alligator clips can be attached to the graphite tube, in one embodiment three alligator clips attached to the top of the graphite tube equally separated, with the clips being part of wires from a frequency source, in one embodiment a function generator, to provide low electromagnetic energy to the particle source through the alligator clips, in one embodiment 2 Hz at an amplitude (Vₚ₋ₚ) of approximately 4.312-4.375V. Isotope production occurs when the user of the set-up inserts powder of an initial isotope in the particle source, in one embodiment Mo, and turns on the low electromagnetic energy source, the function generator, which will permit the generation of particles and of isotopes higher on the periodic table than Mo, in one embodiment Tc-99m. Particles and isotopes can also be produced from the particle source without the insertion of an additional isotope as for example Mo. For instance, particles including non-Standard Model particles, e.g. particles involved in spacetime bending (Tahan, A. C. (2011) Exposing strings in the laboratory with a novel technique. Appl. Phys. Res. 3(2), 39-51, http://dx.doi.org/10.5539/apr.v3n2p39.), have been reported to be generated due to the technique in an international peer-reviewed publication (Tahan, A. C. (2012) Diagrammatic Presentation for the Production of Gravitons and Supersymmetry. Mod. Appl. Sci. 6(9), 76-83, http://dx.doi.org/10.5539/mas.v6n9p76).

Isotope production was scaled by improving the set-up. The original Pyrex tube (No. 9825) used for the invention was changed to a graphite tube (Crucible, Saed/Manfredi G40, 1.5″OD×1.25″ID×3.75″DP), a greater neutron reflector. Only the graphite tube was used to produce Tc-99m, though the Pyrex tube had been used to produce multiple isotopes from Tungsten (W). The graphite tube was replaced periodically; greater counts were achieved with pristine tubes. Higher success in producing Tc-99m occurred when the acid was concentrated (96-98%) and non-oxidized and by increasing the amount of Mo put in the acid. Typically 0.6 g were used, but trials with 1.0 g resulted in higher counts.

Trials were typically run for two hours at 2 Hz. Tc-99m scaling further occurred by incorporating DC electrolysis (Hewlett Packard E3631A, set to 2.9V and 5.0-5.150 A) for one hour prior to exposing the acid and Mo to 2 Hz, the typical frequency. DC electrolysis separated more Hydrogen from the acid exponentially than the maximum ≈2.8 mA that was supplied to the acid in the graphite tube with only 2 Hz (Vₚ₋ₚ≈4.312-4.375V). When using the Pyrex tube, the Vₚ₋ₚ≈12-12.5V provided ≈0.22 A (maximum). Thus, more neutron productions and possible neutron captures with Mo atoms could occur. The direct current and 2 Hz were supplied to the acid and Mo by attaching alligator clips from the current supply or frequency generator to the top of the graphite tube.

Increases when incorporating the DC electrolysis were near 1900 counts. Tc-99m could be produced quickly since Mo is not far on the periodic table from Tc. Since Tc-99m has a short half-life, the longer it is in the invention the more it will decay. Therefore, Tc-99m counts increased when decreasing the 2 Hz exposure to one hour versus the two hours. If the process involved an element further from Tc, running the machine longer could be required.

A trial was performed to verify scaling methods that involved increasing the quantity of initial Mo to 3.5 g, maintaining the 20 mL H₂SO₄, using a new graphite tube and the DC electrolysis, and running the 2 Hz at Vₚ₋ₚ≈4.312-4.375V for one hour. The sample was collected in a VWR 20 mL tube, was inserted in a latex glove in case of leakage, and was placed in a NaI(Tl) well-type scintillation counter using Genie 2000 software.

A background run without the sample and the running of the sample occurred for ten minutes each. Also, a standard Tc-99m sample was examined; the produced sample with the invention was calculated to be releasing 3.53 pCi. The sample was examined near an hour and thirty minutes since it was produced; an immediate examination of the sample may have provided a higher Curie measure. Still, the result confirmed that neutrons had been produced leading to the production of Tc-99m and that the production can be increased. The result is illustrated as FIG. 2 and was produced at an independent laboratory at Massachusetts General Hospital. In other words, confirmation of the enablement and utility of the invention by researchers skilled in the art that understood how to make and use the invention occurred at a well-known institution that had no direct relationship to the inventor.

Scaling should be in consideration of an acid volume to powder ratio. The W trials that involved ICP-MS examinations incorporated approximately 1 mg W to 40 drops H₂SO₄. But trials that changed the ratio to about 1 mg Mo or W to 10 drops H₂SO₄ were less successful. Though the same acid volume had been used for the 3.5 g Mo work, the acid was too saturated with the elements. The samples removed from the apparatus were collections of isotopes produced from Mo since the neutron capture method does not strictly produce Tc-99m. Various separation techniques for different isotopes can be incorporated or developed when required to isolate specific isotopes.

What has been presented is a first technique for in-house, lab bench, isotope production, which can reduce dependency on nuclear reactors. The procedure is portable, scalable, inexpensive, and could be a local source of elements, particularly for research. The hope is that the technique, as to produce Tc-99m, can be a means to supplement demand, production occurring locally whenever needed.

Success with the system (the invention) was not limited to isotope production or particles resulting from isotope productions, e.g. neutrinos, but through experimentation the invention was found could produce particles including, in one embodiment, non-Standard Model particles. Success in producing particles including non-Standard Model particles with the invention was reported in an international peer-reviewed publication (Tahan, A. C. (2012) Diagrammatic Presentation for the Production of Gravitons and Supersymmetry. Mod. Appl. Sci. 6(9), 76-83, http://dx.doi.org/10.5539/mas.v6n9p76). Scholars skilled in the art understood how to make and use the invention and comprehended that it had utility and enablement, including approving the results of creating particles with the invention, thereby consequently recommending for publication the manuscript written about the invention that has the same specification as a parent application U.S. patent application Ser. No. 12/361,540, filed Jan. 28, 2009.

Production of particles involves the same set-up of the invention as previously described to produce isotopes. The invention was found to produce particles including having the ability to manipulate or expose strings, the underlying structures for particles that have been hypothesized but never before observed. The invention showed success in manipulating and exposing strings with the appearance of a D-brane with an open string (Tahan, A. C. (2011) Exposing strings in the laboratory with a novel technique. Appl. Phys. Res. 3(2), 39-51, http://dx.doi.org/10.5539/apr.v3n2p39.) due to the invention. The experimentation that demonstrated that strings exist and could be manipulated for practical purposes including producing particles were uncommon studies of spacetime on Earth. Spacetime is ubiquitous, not simply outside of the Earth atmosphere as typically imagined and studied. Since string theory is well-accepted by theorists to be a theory for quantum gravity (Scherk, J. & Schwarz, J. H. (1974). Dual models and the geometry of space-time. Phys. Letters 52B, 347-350, http://dx.doi.org/10.1016/0370-2693(74)90059-8), an observed curvature of spacetime in the laboratory that accompanied the D-brane due to the invention was considered having been due to having produced gravitons, a non-Standard Model particle, in the same manner as has been described to produce isotopes.

The curvature of spacetime was noted when laser light (Quartet Standard Laser Pointer) directed to the graphite tube to rest on the side of the tube that was closest to the magnet S pole was observed to curve around the tube at the time the D-brane was observed. A D-brane is a higher dimensional string as has been predicted by theorists. What was recorded in the laboratory and approved for publication by scholars skilled in the art and published in an international peer-reviewed publication (Tahan, A. C. (2011) Exposing strings in the laboratory with a novel technique. Appl. Phys. Res. 3(2), 39-51, http://dx.doi.org/10.5539/apr.v3n2p39.) was nearly identical to predictions of how a higher dimensional string should appear, i.e. as a D-brane. The character of all elementary particles has been predicted would be due to underlying strings. For example, the elementary particle photon is responsible for laser light or light generally. If strings exist, photons have been predicted would appear as a D-brane with an open string, the open string being a wave-like thread attached at one end to the higher dimensional string D-brane. In other words, laser light should be observed as a D-brane with an open string if the underlying structure of the light was a string. Accordingly due to the invention, a D-brane with an open string underlying the laser light as diagrammed in FIG. 5 was observed and appeared as had been predicted. (Polchinski, J. (1997). TASI lectures on D-branes, NSF-ITP-96-145, arXiv: hep-th/9611050v2 [hep-th], 1-63.)

The curving around the graphite tube was due to gravitons having been produced and coupling to the tube thereby imparting mass-energy to increase the mass of the tube consequently causing it to bend surrounding spacetime due to the increased mass: as with typical descriptions of massive bodies and gravity—being the curvature of spacetime due to a massive body—in General Relativity. The observation suggested that a carrier of the force gravity had been produced due to the invention as previously described when discussing how to produce isotopes. In other words, again the set-up for the invention is the same to produce particles, though no initial isotope is needed to be inserted in the sulfuric acid of the graphite tube.

Preliminary work involving passing laser light near a reaction vessel graphite tube (Crucible, Saed/Manfredi G40, 1.5″OD×1.25″ID×3.75″DP) where extremely low frequency radio waves interacted with sulfuric acid (H₂SO₄), usually 20 mL, in a static magnetic field (typically 2000 Gauss (Gs), General Electric type 15 A 270) resulted in video captures of the light being pushed and pulled in relation to the position of the vessel. When understanding that light travels in spacetime as is understood in every respectable physical science laboratory globally, influences from the tube were thought causing the bending of nearby spacetime and consequently the light passing in the area. The laser light was simply added to the set-up to test further what was being produced with the invention. Again the description of the set-up of the invention should be understood to be the same as the previously described set-up to produce isotopes.

To understand what might be bending spacetime that resulted in the unusual light observations, a hypothesis involved if the laser light would curve around the holding vessel (graphite tube) if gravitons were being produced due to the specification of the invention. Quantum gravity (gravitons), produced due to the invention, encountering the tube would cause the tube to become more massive, i.e. increasing gravitational influence by bending surrounding spacetime, since gravitons have been predicted would be carriers of mass or mass-energy (Zwiebach, B. (2004). A first course in string theory. Cambridge: Cambridge University Press.).

The laser studies that resulted in the appearance of the D-brane with the open string had the light directly on the side of the graphite tube. Video captured spacetime bending and a multi-dimensional object that resembled a membrane (brane) with an open string (D-brane with an open string) at the position of where the light was traveling toward the tube. The studies confirmed the enablement and utility of the invention since only the low electromagnetic frequencies, in one embodiment 2 Hz at an amplitude (Vₚ₋ₚ) of approximately 4.312-4.375V when using the graphite tube, were effective on the particle source, in one embodiment sulfuric acid, in the magnetic field, in one embodiment 2000 Gs.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the invention when the frequency source is connected to the holding vessel.

FIG. 2 is a graph from a scintillation detector demonstrating the peak observed for Tc-99m after Mo was inserted in the invention.

FIG. 3 is a diagrammatic illustration of the invention when the frequency source is connected to the holding vessel and the laser light is positioned on the holding vessel tube.

FIG. 4 is how the laser light appeared on the graphite tube before the extremely low electromagnetic frequency was turned on.

FIG. 5 shows the bending of the laser light around the tube as the D-brane with the open string appeared.

FIG. 6 is the D-brane with the open string representing the laser light that was exposed due to the invention that became deformed and rotated due to a high gravitational area in the holding vessel graphite tube.

FIG. 7 is an illustration of using the FIG. 1 invention for a new means of communications, specifically permitting superpositioning or entangled communications.

FIG. 8 shows use of the FIG. 1 invention in computing, specifically creating a superpositioning or entangled communications optical computing method.

FIG. 9 is one embodiment of how the FIG. 1 invention produces non-Standard Model particles. Though not in the diagram, an electron neutrino should be understood also to have resulted from the electron capture. The neutrino was intentionally left-out of the Figure to eliminate the possibility of the figure being too cluttered to be readable.

FIG. 10 illustrates a new particle collider due to the FIG. 1 invention.

FIG. 11 is the illustration of use of the FIG. 1 invention for vehicle transport or conveyance, primarily using the ability to bend spacetime due to the FIG. 1 invention.

FIG. 12 is the design of the circuit to provide the low electromagnetic frequency to the particle source that was originally used before incorporating a function generator to provide the frequency.

FIG. 13 presents the laser light on the tube appearing in multiple locations simultaneously, i.e. being superpositioned, due to particles produced by the invention.

### DETAILED DESCRIPTION

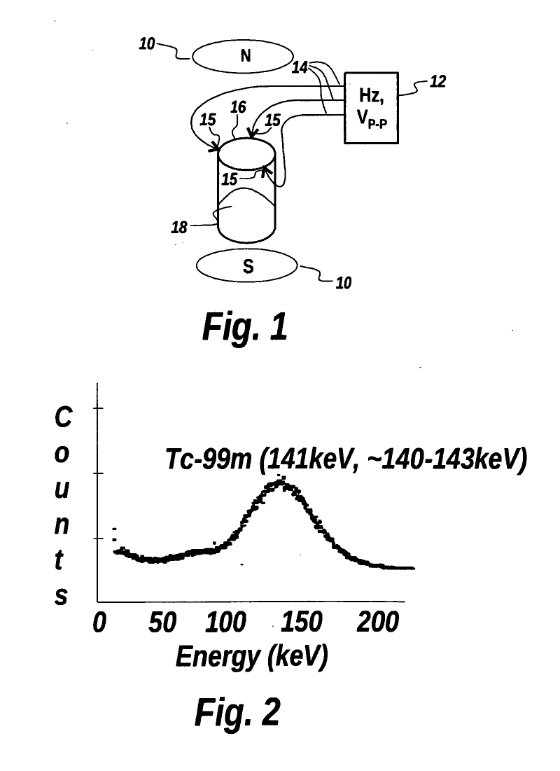

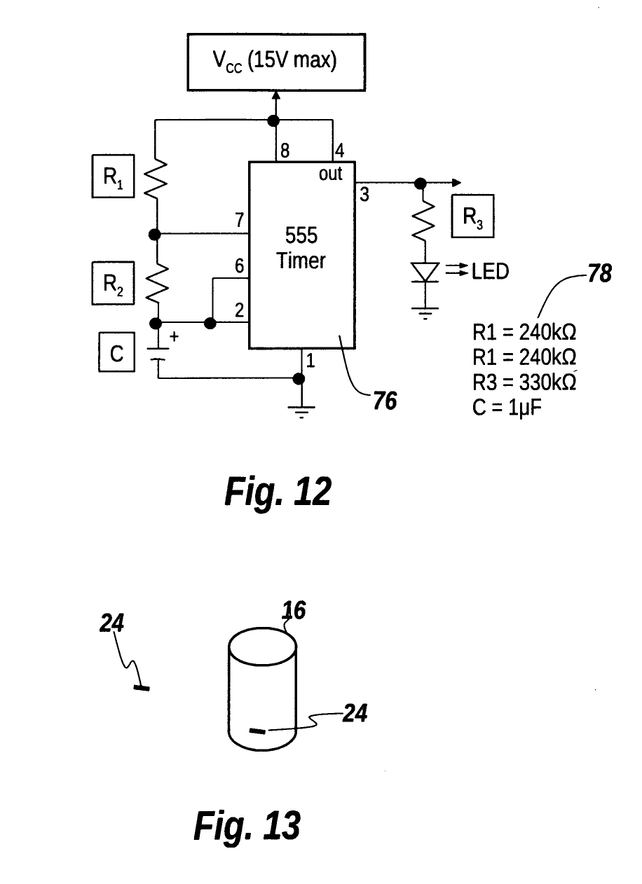

Referring now to FIG. 1, the ability to produce isotopes and particles involves placing a particle source 18 in a holding vessel 16 in a moderately strong magnetic field 10. If the holding vessel is a conductor, low electromagnetic frequency from a source 12 as a function generator can be delivered to the particle source 18 with wires 14 leading from the frequency source 12. The original frequency source was the designed circuit of FIG. 12, which permits operation of the frequency with a battery thereby making the invention portable and useable in environments without consistent power, as from wall outlets. The wires 14 can provide the frequency with a specific amplitude, in one embodiment being 2 Hz with an amplitude approximately 4-4.375V when the vessel is a graphite tube (Crucible, Saed/Manfredi G40, 1.5″OD×1.25″ID×3.75″DP), by connecting the alligator clips 15 at the end of the wires 14 to the holding vessel 16, in one embodiment being a graphite tube. A particle source is defined in one embodiment as a provider of Hydrogen, e.g. Hydrogen being easily supplied from a source as a strong acid that is defined as a proton (Hydrogen) donor. The particle source for experiments utilizing the invention (FIG. 1) was concentrated (96-98%) sulfuric acid. The tube used for the FIG. 1 set-up was mainly a graphite tube positioned at the 2000 Gs region of the magnetic field. In other words, field strength can vary slightly depending on location between magnet poles especially of a gap magnet as used for the majority of trials. A measure of 2000 Gs was ≈0.01 m from the S pole.

The invention may be considered similar to NMR but FIG. 1, particularly considering that the extremely low frequencies were not affecting Hydrogen alignments, should explain how the technique differs. The components that should be maintained consistently are the frequency and amplitude (≈2 Hz (2.000-2.012 Hz), Vₚ₋ₚ=4.312-4.437, predominately 4.375), graphite tube, distance from the S pole to ensure a consistent 2000 Gs, and the concentrated sulfuric acid (96-98%). Impurities should be limited in the acid supply, which should be replaced periodically. If replication at 2 Hz is unsuccessful, the amplitude should be examined. The setting would be less or more relative to a set-up change, e.g. different Hydrogen source or holding vessel.

Referring now to FIG. 2, enablement and utility of the FIG. 1 invention was confirmed when a laboratory at Massachusetts General Hospital produced the FIG. 2 graph indicating that Tc-99m was in a sample taken from the invention when Mo was inserted in the particle source. In other words, FIG. 2 demonstrates the ability to produce isotopes with the invention. The scintillation detector graph shows a peak that represented presence of Tc-99m. Various experiments, control trials, were conducted to test if the detected Tc-99m may have had a different source. For example, components of the invention as the particle source sulfuric acid were tested, but the only conclusion that could be accepted was that the Tc-99m could only have been produced from the Mo that had been inserted in the invention. Also, the short half-life of Tc-99m limited possibilities of other sources of the isotope being responsible for the graph since the isotope is not readily available, particularly in the environment, due to its short half-life.

Again the graph was provided by an independent laboratory at Massachusetts General Hospital, the graph confirming that isotopes can be produced with the invention. FIG. 2 is further independent confirmation of utility and enablement of the FIG. 1 invention, particularly that scholars skilled in the art understood how to make and use the invention. An independent laboratory at Massachusetts Institute of Technology had previously provided Inductively Coupled Plasma Mass Spectroscopy (ICP-MS) data confirming the utility and enablement of the invention to produce isotopes as reported in U.S. patent application Ser. No. 12/361,540, filed Jan. 28, 2009. In other words, the isotopes produced depend on the initial isotope inserted in the tube, as previously stated with the example of isotopes being produced when W was inserted in the invention. Accordingly, Tc-99m is only one example of an isotope that can be produced with the invention.

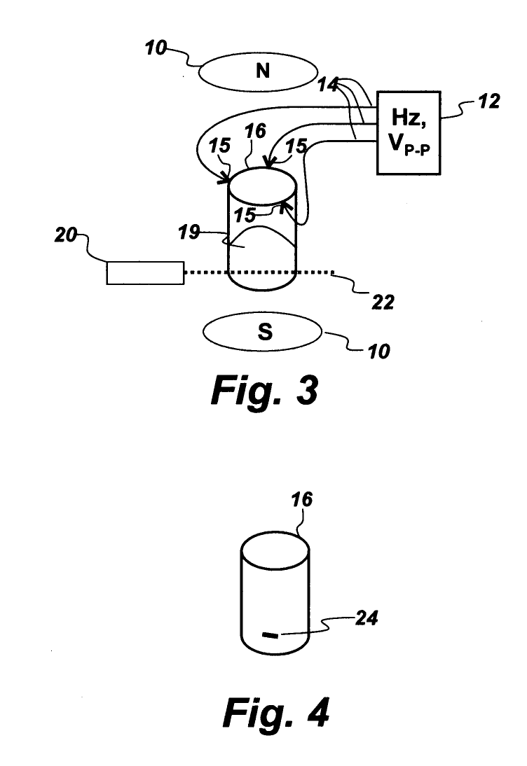

Referring now to FIG. 3, experiments were conducted with laser light, work with the FIG. 1 invention eventually leading to research with light 22 from a laser 20 being placed on the side of the holding vessel 16—a graphite tube having been used in experiments. The light from the laser (Quartet Standard Laser Pointer) was positioned on the S pole side of the tube, approximately 0.017 m from the center and 0.01-0.02 m from the bottom of the tube. The positioning created an ≈0.004-0.005 m line on the tube, as illustrated in FIG. 4, but did not prevent the light from entering a vacuum photocell that was connected to a digital oscilloscope. The same number of wooden blocks was placed under the stand for the laser and the photocell to raise the objects for alignment. The photocell and oscilloscope are not in FIG. 3 since the devices were not part of the invention and were not crucial to the experiments, apart from allowing for consistent placement of the laser on the tube. Consistent placement of the laser on the tube could be performed without the photocell and oscilloscope. The laser is not a component for the invention to produce isotopes and particles. The light was incorporated only to examine influences exiting the graphite tube. However, incorporation of the laser light can allow for visualization of a D-brane with an open string.

The particle source is labeled 19 in FIG. 3 because it contained more graphite atoms from the graphite tube during the laser light work that allowed for the appearance of the D-brane with an open string. In other words, gravitons produced with the invention coupled to the graphite atoms, which created the equivalence of a high gravitational area in the tube. The area contributed to the appearance of the D-brane with the open string as will be discussed when explaining the other figures.

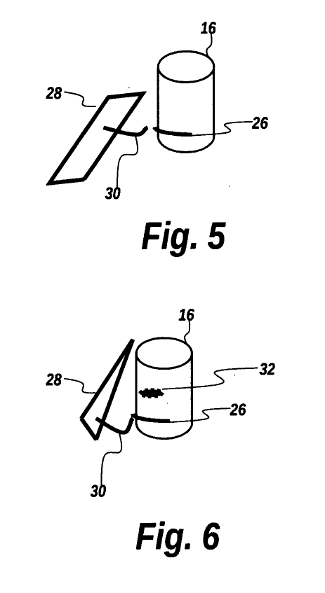

The tube should be clamped in the area of the magnetic field measuring approximately 2000 Gs. Slight distance differences toward the S pole of the gap magnet were not a factor. Past trials had the tube ≈0.01-0.012 m from the S pole. For the trial that presented the D-brane of FIG. 5, the distance of the tube to the S pole was 0.004-0.005 m; the tube was angled near five degrees toward the S pole. The laser was 0.34-0.35 m from the tube. The function generator providing the 2 Hz frequency and amplitude was connected to a LED on a breadboard from which wires provided a specific frequency and amplitude to the graphite tube. Three alligator clips were attached to the top of the tube in a triangular formation as diagrammed in FIG. 1, though only one wire was needed to provide the approximate 4.375V amplitude. The three wires were maintained to ensure that the frequency and amplitude were reaching the tube, particularly considering possible malfunction during a trial as due to corrosion of a clip. Frequencies and amplitudes were confirmed with an oscilloscope prior to each trial. The laser was kept on by a clamp during all experiments, and the batteries were changed before every trial to guarantee steadiness of the light, unless not changing the batteries was procedural. The photocell was 0.63-0.64 m from the graphite tube, which was approximately 0.098-0.099 kg. The clamp that held the tube was about 0.230 kg, and the stand to which the clamp was attached was near 1.458 kg, which included the mass of the clamp holder that was ≈0.153 kg.

Referring now to FIG. 4, prior to the function generator being turned on the laser light 24 appeared on the tube 16 as explained related to FIG. 3. FIG. 4 shows the appearance of the laser light.

Referring now to FIG. 5, at approximately nine minutes and eight to nine seconds after the low electromagnetic frequency was turned on bending of the laser light 24 in FIG. 4 around the tube occurred appearing as the light 26 in FIG. 5 while the D-brane 28 with the open string 30 appeared. The laser light on the tube 16 should be understood to have not been adjusted or altered. The only difference between FIG. 4 and FIG. 5 is that the 2 Hz frequency with the amplitude was provided to the particle source sulfuric acid that resulted in FIG. 5. The contrast between FIG. 4 and FIG. 5 should be noted to have been due to particle generation that resulted in the influence of the light; in other words, the D-brane with the open string appearing and the bending of the light around the tube was due to particle production in the tube. The influencing of the light continued until nine minutes and fourteen to fifteen seconds.

The appearance of the D-brane with the open string and bending of the light around the tube were recorded, including the deforming and rotation of the D-brane with the open string as shown in FIG. 6. A camera (Kodak EasyShare C180) was clamped to a stand above the light 24 on the tube at about 90-100 degrees and near 0.01-0.02 m in front of the outer edge of the tube toward the West side in relation to the magnet poles. The camera was near 0.29-0.3 m from the base of the stand to allow it to be as close as possible without touching the set-up or being in the path of the laser. The camera location should be altered if needing to improve recordings; zooming can be used to avoid adjusting the camera position on the stand. Accordingly, the D-brane with the laser light appearance was recorded and documented in a peer-reviewed publication. (Tahan, A. C. (2011) Exposing strings in the laboratory with a novel technique. Appl. Phys. Res. 3(2), 39-51, http://dx.doi.org/10.5539/apr.v3n2p39.)

The video recording of the D-brane with the open string appearing, deforming, and rotating can be found at bliptv.com/actahan. The ideal method to see all proceedings involving the D-brane is to reduce the video speed. For example, the lowest speed provided by the software that allowed for visualization of the movement of the D-brane with the open string was 0.03×, which permitted the best views for capturing the images of FIGS. 5 and 6. Watching the video in conjunction with the related peer reviewed publication (Tahan, A. C. (2011) Exposing strings in the laboratory with a novel technique. Appl. Phys. Res. 3(2), 39-51, http://dx.doi.org/10.5539/apr.v3n2p39.) would best allow for understanding of the deformation of the D-brane with the open string, particularly when slowing the video as best as possible.

Referring now to FIG. 6, the light 26 bent around the holding vessel graphite tube 16 since gravitons were produced that coupled with the tube thereby imparting mass or more specifically mass-energy. The increased mass influenced the spacetime surrounding the tube in which the light traveled thereby redirecting the path of travel. In other words, the light that was placed on the side of the tube curved around the tube since spacetime curved around the tube; the light in spacetime as typically explained in discussions of General Relativity appeared curved since its path in spacetime became curved.

The D-brane 28 with the open string 30 is the same D-brane 28 with the open string 30 in FIG. 5. The D-brane with the open string in FIG. 6 is deformed and rotated due to a high gravitational area 32 that appeared in the tube and can be seen in the peer reviewed publication (Tahan, A. C. (2011) Exposing strings in the laboratory with a novel technique. Appl. Phys. Res. 3(2), 39-51, http://dx.doi.org/10.5539/apr.v3n2p39.) documenting the appearance. Placing the camera in an appropriate position for recording was difficult and the delay caused graphite powder from the pristine tube to leak to the acid that was in the tube. Accordingly, a larger than usual amount of graphite powder was in the tube at the time that gravitons were produced, and the gravitons coupled to the graphite powder in addition to the graphite tube. The gravitons encountering the graphite powder created a high gravitational area in the tube, which on the video recording seemed to rotate. The graviton production was accompanied by supersymmetric particles, primarily the graviphoton and graviscalar that were involved in the appearance of the D-brane with the open string.

The rotation of the high gravitational area in the tube caused a frame dragging or rotation of surrounding spacetime. The rotation also caused the D-brane with the open string to rotate and become deformed as in FIG. 6. The D-brane with the open string must be remembered to be the underlying structure of the laser light. The invention allowed for exposure of the underlying string structure. The laser light being in a fixed location, on the side of the tube, was why the D-brane with the open string was in a fixed location; the D-brane with the open string can be thought equivalent to the laser light. Thus, as the high gravitational area rotated the D-brane with the open string being fixed in place rotated and deformed since it could not move from its location since again the laser light was in place, i.e. not moving but steady on the tube. Accordingly, FIG. 6 shows the deformation and rotation due to the high gravitational area in the tube that can be thought equivalent to a rotating micro-black hole.

FIG. 6 demonstrates that high gravitational areas can be produced with the FIG. 1 invention. The high gravitational areas, black holes or micro-black holes, should be remembered to have been due to the invention to produce particles, particularly gravitons. In other words, the black holes are not the same as black holes found outside of the laboratory due to stellar collapse but are due to non-Standard Model particle production due to the FIG. 1 invention, specifically producing gravitons.

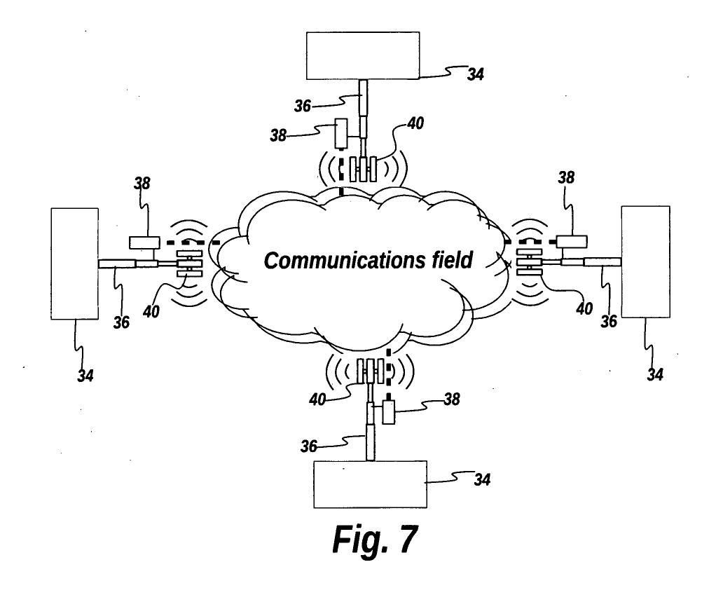

Referring now to FIG. 7, continued work with the laser light led to the observation that when particles due to the FIG. 1 invention encountered the laser light directly, particularly without a prolonged encounter as due to a rotating gravitational area, the laser light would appear in a different position while still appearing on the tube as presented in FIG. 13. In other words, particles produced with the invention allowed the light to appear superpositioned, appear in multiple locations simultaneously, which is a principle commonly observed and discussed as a quantum mechanics phenomenon. The light appearing superpositioned rather than as the D-brane with the open string was thought due to the affect on the light having been particularly greater than normal for FIGS. 5 and 6 due to the excess graphite power in the tube. The excess powder in the tube created a larger and more sustained gravitational area that had a larger affect on surrounding spacetime, due to gravitons that had coupled to the graphite atoms (powder), and consequently the laser light thereby allowing the light to appear as the D-brane with the open string.

The laser light simply appeared superpositioned due to gravitons having interacted with the light. Also, the direction in which the particles from the tube encountered the light could affect if the light could appear as the D-brane with the open string of FIG. 5. Thus, the particles from the tube were understood could be produced to interact with the light for different results: superpositioning, appearance of a D-brane with an open string, etc.

FIG. 7 takes advantage of the ability of the invention to create superpositioning that can be used for communications. Mass-energy, specifically the gravitons, were found in experiments could be directed over distances to impart mass-energy to objects. The mass-energy was found to be along the path to the objects in the experiments, i.e. gravitons directed from the invention created a field as the particles traveled. FIG. 7 uses the invention for communications by incorporating the idea of creating a graviton field that can superposition light. The optical communications system involves base stations 34 at different locations that use the invention to create particles with the invention, particularly gravitons, and directs the particles to an area. The invention is at the top of the towers 40 that are at the top of the base stations 34. The components for the invention are replenished through the support beams of the tower 36. The light used for communications is provided by a light source 38, similar to a fiber optic source signal or a laser, that directs the light to the field that is created by the invention housed in the different towers 40 with base stations 34 positioned in different locations. Accordingly, when light signals from the source 38 at one tower enters the communications field due to the gravitons from the invention, the light signals are superpositioned so that the communications exist everywhere in the communications field simultaneously. Specifically, when a signal is sent from one location, when it enters the field all the other towers or any communications device with access to the communications field will instantaneously receive the communication.

The towers can relay the received communications to devices not in contact with the communications field. All base stations can participate in continuously producing the field or periodically contributing to the production, particularly if a station is a back-up for production of the graviton field. The base stations would be run by operators that send the light signals or the signaling and maintenance of the invention in the towers can be automated. Accordingly due to the invention at the towers in different locations, the communications field is an area permitting entangled communications, i.e. entanglement.

The base stations 34 can be in different cities or regions of a country or of the world depending on the size of the field that is to be created. For example, in FIG. 7 the bottom 34 could be in Houston, Tex., USA, and the right 34 could be in Paris, France. The top 34 could be in Buffalo, N.Y., USA, and the left 34 could be in Canberra, Australia. Also, base stations 34 with towers could also be in areas between the mentioned cities to create a more consistent and connected field.

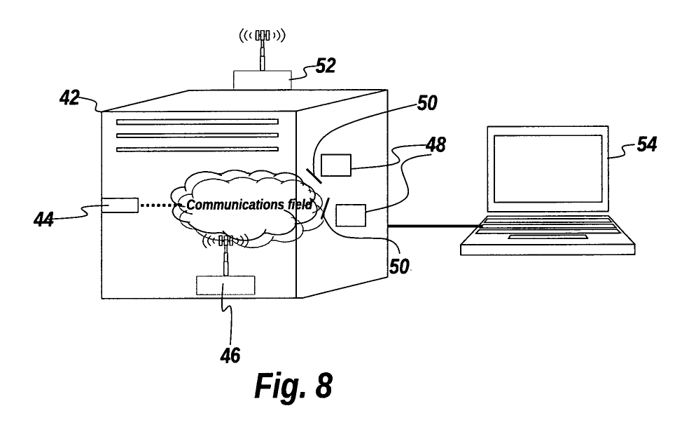

Referring now to FIG. 8, the communications system of FIG. 7 can be reduced in size to be used for computing. The invention 46 would be housed in a box 42 as typically seen with desktop computers, the enclosure housing the superpositioning or entangled communications optical computing method. The invention is the same design as the base station and tower in FIG. 7 because the same components would be involved. The difference would be location of the light sources 44 to communicate data in the computer. Gates 50 would exist to control the hardware or function unit 48 that receives the data, i.e. in computing not all processes need to run simultaneously so that the gates would control operations. The computer box 42 would be connected to a monitor and keyboard 54 to allow for use of the computer. A tower for the invention 52 could also exist on top of the computer box 42 so that computers can communicate or to permit an entangled communications system between computers as described in FIG. 7.

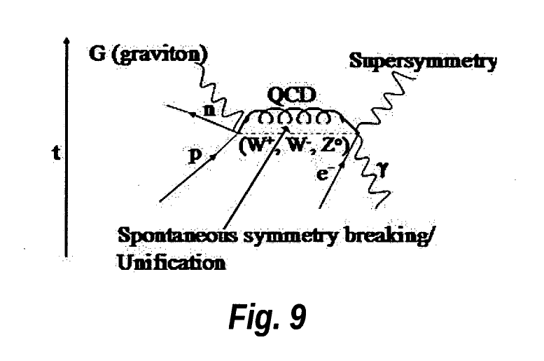

Referring now to FIG. 9, the invention is diagrammed showing the initial components leading to particles. FIG. 9 is one embodiment of how the FIG. 1 invention produces particles, including non-Standard Model particles. The diagram illustrates an electron capture in Hydrogen (p) process involving the low electromagnetic frequency (γ) that led to the graviton and supersymmetry observations in trials: e.g. spacetime bending. (Tahan, A. C. (2011) Exposing strings in the laboratory with a novel technique. Appl. Phys. Res. 3(2), 39-51, http://dx.doi.org/10.5539/apr.v3n2p39.) Though not in the diagram, an electron neutrino should be understood also to have resulted from the electron capture. The neutrino was intentionally left-out of FIG. 9 to eliminate the possibility of the figure being too cluttered to be readable.

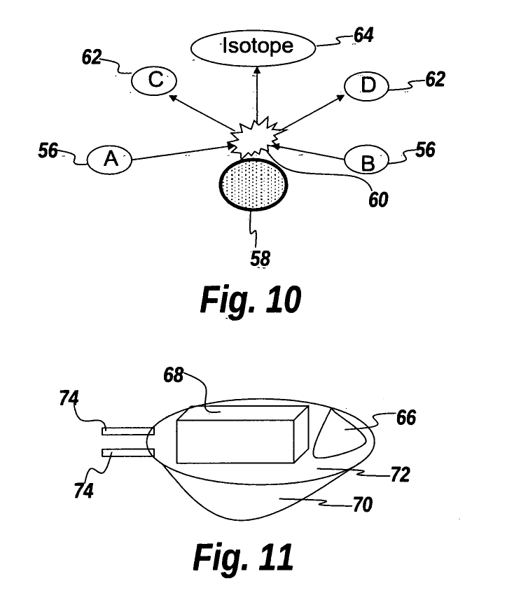

Referring now to FIG. 10, the ability to create high gravitational areas by producing gravitons with the invention would allow for the use of the invention as a novel form of particle collider, as illustrated as FIG. 10. A high gravitational area 58, as involving graphite powder as having occurred in the work that exposed the D-brane with the open string, is produced in a particle source with the invention of FIG. 1. Particles A and B 56 would be attracted to the high gravitational area. The bodies in being attracted to the area would collide 60 near the region of the gravitational area. The result of the collision would be new particles 62. The gravitational area would disappear as in experiments or the invention could be turned off to allow for the new particles rather than the new particles also being attracted to the high gravitational area. The collider can also be used to make new isotopes 64, including the initial particles 56 being isotopes or elements including particles if needed to make an isotope. Thus FIG. 10 is a novel, less expensive, and simpler means to create particle collisions compared to present collider facilities.

Referring now to FIG. 11, the FIG. 1 invention has been observed in experiments and described with FIG. 5 and FIG. 6 to allow for the bending of spacetime. The invention has been described can be housed in compartments of different forms. Accordingly, FIG. 11 shows the invention to be incorporated in a vehicle for transportation. Vehicles incorporating the FIG. 1 invention to bend spacetime for transportation can be considered to be incorporating the invention as a system of spacetime adjustable navigation. The incorporation is to utilize spacetime bending to improve travel particularly to distant locations. When an object in a position can bend spacetime, the object essentially is bringing a different object closer than before spacetime was bent. The scenario can be thought as spacetime being folded closer to the object and when it is no longer bent, the spacetime around the object will return to its state before the bending, as had been observed in the experiments including the trial of FIG. 5 and FIG. 6.

The vehicle of FIG. 11 thus contains the invention in a compartment 70. The operating or driving area 66 is from where the vehicle can be driven. The vehicle can carry cargo 68, the vehicle being equivalent to a shipping vessel, or the area for cargo 68 can be used as a passenger area. In other words, the vehicle design can be modified depending on the intended use while still utilizing the invention 70 for transport. The base 72 of the vehicle can be any shape, permitting different designs as for operator or customer preference or for functionality, e.g. due to aerodynamics or a shape that facilitates travel.

The invention 70 can be controlled from the operating or driving area 66, or the process can be automated if the vehicle is unmanned. When the invention has released particles gravitons that couple to the walls of the compartment 70, spacetime as observed in experiments with the laser light bending around the holding vessel graphite tube will be bent. To take advantage of the reduced distance to a location due to the bent spacetime, the vehicle will have to move forward while spacetime is bent, which can be done with the propulsion components or rockets 74. Thus, the rockets can fire automatically when spacetime is bent, particularly since experimentation showed that the production of gravitons is a timed process so that the firing of the rockets can be synchronized automatically, or the rockets can be operated by a driver in the operating or driving area 66. The vehicle of FIG. 11 has been discussed as incorporating the invention for travel due to spacetime bending. However, the invention allowing for particle production can permit produced particles and related antiparticles to power a vehicle at least in terms of the rocket propulsion, as due to the output from particle-antiparticle collisions.

Referring now to FIG. 12, a circuit design is presented that can provide a low frequency signal mainly due to the arrangement of specific resistors and capacitors 78 and a 555 timer 76. The circuit was originally used before incorporation of the function generator. FIG. 12 produces a 2 Hz square wave, which proved effective in experiments as did a sine wave for use as part of the invention. Components as an IC socket can be incorporated, as at 76 under the 555 timer, to allow for the insertion of wires for increasing the number of antennas carrying the low frequency signal from the circuit. Binding posts allow for the connection of alligator clips to carry frequency away from the circuit. The circuit can be plugged in a power outlet by including a power cord and adaptor, but the ideal advantage of the circuit is to allow for the invention to be run on a battery. A battery holder can be attached to the circuit to provide the electromagnetic energy to the invention by battery power if a power outlet is unavailable, which allows the invention to be useable essentially at any location.

Referring now to FIG. 13, experimentation showed that when particles from the invention, particularly gravitons, encountered the laser light, the light on the tube 24 could appear in multiple locations simultaneously, i.e. being superpositioned. The light appears a distance from the tube since the laser light as it approached the graphite tube, after gravitons coupled to the tube, experienced gravitational lensing thereby causing the light to be superpositioned while being deflected around the tube to a new location. The light at the new location is labeled 24 also because it is the same light from the laser that reached and appeared on the tube while being deflected (gravitational lensing) and superpositioned.

What is claimed is:

1. A system for generating particles and isotopes, comprising the steps of:
positioning a particle source in a holding vessel;
placing the vessel in a magnetic field;
and subjecting the particle source to a low electromagnetic frequency at a specific amplitude or amplitude range.

2. The method of claim 1, wherein the particle source is a source of Hydrogen.

3. The method of claim 1, wherein the particle source is a strong acid.

4. The method of claim 1, wherein the holding vessel is made of a conducting material.

5. The method of claim 1, wherein the holding vessel is made of a neutron reflective material, in one embodiment a graphite tube.

6. The method of claim 1, wherein Standard Model particles are produced.

7. The method of claim 1, wherein the produced isotopes are of the same element initially inserted in the particle source.

8. The method of claim 1, wherein the produced isotopes are different from the initial elements inserted in the particle source.

9. The method of claim 1, wherein particles produced with the technique can cause superpositioning.

10. The method of claim 1, wherein non-Standard Model particles are produced including gravitons and supersymmetric (supersymmetry) particles.

11. The method of claim 1, wherein energy is sourced directly from a nucleon or body by increasing the underlying string vibrations of the body thereby increasing the energy since increasing string vibrations is equivalent to increasing energy.

12. The method of claim 1, wherein spacetime is bent significantly to allow the bent areas to be used for gravitational lensing or the redirecting of objects traveling to it, which can be used in one embodiment for weapon defense.

13. The method of claim 1, wherein redshifting or blueshifting is created.

14. The method of claim 1, wherein spacetime is bent significantly to be thought equivalent to black holes, which can be sources of particles and energy.

15. The method of claim 1, wherein strings are manipulated, exposed, or used for applications as energy supply.

16. The method of claim 1, wherein produced high gravitational areas or black holes can be tailored especially for industrial or technical applications.

17. The method of claim 1, wherein hybrid and intermediate particles are produced.

18. The method of claim 1, wherein mass-energy is produced.

19. The method of claim 1, wherein mass-energy carriers as gravitons are produced that can interact with objects thereby imparting mass-energy for various functions including gravitational lensing.

20. The method of claim 1, wherein directing a laser toward the holding vessel so that the laser light is on the side of the vessel at the magnet S pole will allow for the visualization of subatomic structures, in one embodiment strings particularly a D-brane with an open string.

21. The method of claim 1, wherein high gravitational areas, black holes, or micro-black holes can be produced.

22. The method of claim 1, wherein particles produced with the invention can allow for gravitational lensing.

23. The method of claim 1, wherein particles produced with the invention can be used in computing, including quantum or optical computing.

24. The method of claim 1, wherein particles are produced for transportation, including bending spacetime to improve long distance travel that can be described as spacetime adjustable navigation.

25. The method of claim 1, wherein particles and anti-particles are produced for particle-antiparticle annihilation.

26. The method of claim 1, wherein isotopes are produced without the need for an isotope generator.

27. The method of claim 1, wherein extra dimensions are exposed.

28. The method of claim 1, wherein energy is generated.

29. The method of claim 1, wherein entropy is created.

30. The method of claim 1, wherein generated energy, particles, or entropy are projected, in one embodiment from high gravitational areas, on two dimensional surfaces to produce three or higher dimensional images thereby creating holography or holograms.

31. The method of claim 1, wherein particles or energy are used for communications, including modulating related waves—e.g. graviton (gravity or mass-energy) waves—to carry information.

32. The method of claim 1, wherein the spin-2 of produced gravitons is used for quantum computing.

33. The method of claim 1, wherein energy is sourced through a nucleon, in one embodiment the proton, by increasing its string vibrations.

34. The method of claim 1, wherein isotope or particle production is used for nuclear waste management.

35. The method of claim 1, wherein particles and isotopes are produced for medical treatments and diagnostics.
